(19) United States
(12) Patent Application Publication
(10) Pub. No.: US 2018/0154945 A1
(43) Pub. Date: Jun. 7, 2018

(54) CHILD MOBILITY DEVICE

(71) Applicant: Texas Tech University System, Lubbock, TX (US)

(72) Inventors: Sebastian Bahamonde, Katy, TX (US); Edwin Alvin Erlbacher, III, Dallas, TX (US); Joshua Silver, McKinney, TX (US); Jeffrey Hanson, Lubbock, TX (US); Michael Blanchette, Little Elm, TX (US); Andrew Shannon, Houston, TX (US); Joseph Cumbest, Lubbock, TX (US); Pamela Baker, Lubbock, TX (US)

(73) Assignee: Texas Tech University System

(21) Appl. No.: 15/834,966

(22) Filed: Dec. 7, 2017

Related U.S. Application Data
(60) Provisional application No. 62/431,197, filed on Dec. 7, 2016.

(51) Int. Cl. B62D 21/18; B60K 7/00; B60K 17/04; B60K 1/04; B60N 2/26; B60N 2/015; B60L 11/18; B60L 15/20

(52) U.S. Cl. CPC B62D 21/18; B60K 7/0007; B60K 17/043; B60K 1/04; B60Y 2200/83; B60N 2/015; B60L 11/1877; B60L 15/20; B60K 2007/0061; B60N 2/265

(57) ABSTRACT

A toddler mobility system and apparatus comprising a chassis, two casters attached to the front of the chassis, two wheels attached to a rear of the chassis, a first motor operably connected to one of the at least two wheels, a second motor operably connected to another of the at least two wheels, a battery configured to supply power to the motors, a body affixed to the chassis and covering the chassis, the body further comprising an integrated seat, an integrated backrest, a control system wherein the control system further comprises a microcontroller operably connected to a joystick, and a motor controller that receives control input from the microcontroller and adjusts power to the first motor and the second motor independently, wherein the toddler mobility system is configured for users weighing 50 pounds or less.

### CROSS REFERENCE TO RELATED PATENT APPLICATIONS

This patent application claims the priority and benefit, under 35 U.S.C. § 119(e), of U.S. Provisional Patent Application Ser. No. 62/431,197, filed Dec. 7, 2016, entitled “CHILD MOBILITY DEVICE.” U.S. Provisional Patent Application Ser. No. 62/431,197 is herein incorporated by reference in its entirety.

### TECHNICAL FIELD

The present embodiments are generally related to vehicles. The embodiments are related to methods and systems for vehicles for children. The embodiments are additionally related to methods and systems for mobility devices. More specifically, the embodiments are related to methods and systems for child mobility devices.

### BACKGROUND

Roughly 3% of all babies born in the United States have some type of major birth defect or disability. Disabilities that hinder the mobility of a child, or make it difficult for them to move on their own, are a significant, and as yet, unsolved problem. The problem that infants and toddlers face with a mobility disability is that they are unable to explore the world around them. While it may seem plausible to address this problem by having a parent move them around to explore different objects, the inability for a child to move on their own accord affects the development of their cognitive spatial awareness.

A major contributing factor in child development is cognitive spatial awareness, which includes development of the tools necessary for a basic understanding of the surroundings; for example, how far away things actually are. Children develop spatial awareness as a toddler, when they begin to crawl and walk. Moving from place to place and object to object helps a child begin to grasp the concept of the distance and size of the things around them. Having the ability to improve cognitive spatial awareness also improves toddlers' developmental capacity in a variety of subjects including math and reading skills.

Thus, one key to improving spatial awareness is self-initiated mobility. Toddlers develop much faster if they are able to control their own movement. Toddlers cannot develop the skills necessary for development if they are picked up or carried from one location to another. This becomes a problem for toddlers who were born with disabilities that hinder their own movement. This could include missing limbs, stiff joints, or any other medical condition that keeps the toddler from moving on their own, and discovering the world around them.

In some cases, a child with a movement disability may be provided a power chair, but this becomes difficult for a child under the age of five who is growing quickly and does not fully understand how to control such a bulky device. Such devices are not designed to hold a small child. In addition, insurance companies often will only support purchase of a power chair every ten years. A toddler will out grow their chair in just a few years and/or be undersized for years while using the chair. In addition, most power chairs are too large for the child to enter or exit on their own. The chair size also removes the child from the immediate surrounding environment. This makes it very difficult to improve a child's cognitive spatial awareness and furthermore, their mental development. If a child is not able to develop these cognitive skills at an early age, then they are at risk of suffering from insufficient mental development.

As such, improved methods and systems for providing children, such as toddlers, mobility devices designed to allow them to explore their environment autonomously are required.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a vehicle.

It is another aspect of the disclosed embodiments to provide methods and systems for providing mobility for children.

It is another aspect of the disclosed embodiments to provide a method and system for providing mobility-impaired children a vehicle to facilitate mobility and cognitive development.

It is another aspect of the disclosed embodiments to provide methods and systems for an improved wheeled vehicle designed to facilitate free exploration and transportation of mobility-impaired toddlers.

For example, in the embodiments disclosed herein, a toddler mobility system and apparatus comprises a chassis, two casters attached to the front of the chassis, two wheels attached to a rear of the chassis, a first motor operably connected to one of the at least two wheels, a second motor operably connected to another of the at least two wheels, a battery configured to supply power to the motors, a body affixed to the chassis and covering the chassis, the body further comprising an integrated seat, an integrated backrest, and a seatbelt, a control system wherein the control system further comprises a microcontroller operably connected to a joystick, and a motor controller that receives control input from the microcontroller and adjusts power to the first motor and the second motor independently, wherein the toddler mobility system is configured for users weighing 50 pounds or less.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a child mobility device chassis in accordance with the disclosed embodiments;

FIG. 2 depicts a caster assembly in accordance with the disclosed embodiments;

FIG. 3A depicts a drivetrain assembly in accordance with the disclosed embodiments;

FIG. 3B depicts another view of the drivetrain assembly in accordance with the disclosed embodiments;

FIG. 3C depicts a view of parts associated with a drivetrain assembly in accordance with the disclosed embodiments;

FIG. 3D depicts an interface between a chassis and a drivetrain assembly in accordance with the disclosed embodiments;

FIG. 3E depicts an adapter plate in accordance with the disclosed embodiments;

FIG. 3F depicts motor mounts associated with a drivetrain assembly, in accordance with the disclosed embodiments;

FIG. 4A depicts a top view of a rear portion of a child mobility device, in accordance with the disclosed embodiments;

FIG. 4B depicts a battery shroud in accordance with the disclosed embodiments;

FIG. 5 depicts a microcontroller in accordance with the disclosed embodiments;

FIG. 6 depicts a motor controller in accordance with the disclosed embodiments;

FIG. 7 depicts an electronics board for housing a microcontroller and/or motor controller, in accordance with the disclosed embodiments;

FIG. 8 depicts a wiring diagram of a child mobility device, in accordance with the disclosed embodiments;

FIG. 9 depicts a body associated with a child mobility device, in accordance with the disclosed embodiments; and

FIG. 10 depicts a child mobility device, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements, or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. All of the compositions and/or methods disclosed and claimed herein can be made and executed without undue experimentation in light of the present disclosure. While the compositions and methods of this invention have been described in terms of preferred embodiments, it will be apparent to those skilled in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The embodiments disclosed herein provide systems for enhancing the independent mobility of children. Specifically, the embodiments disclosed herein are designed to provide toddlers with mobility impairments, the ability to independently navigate an environment with the aid of a specially designed vehicle.

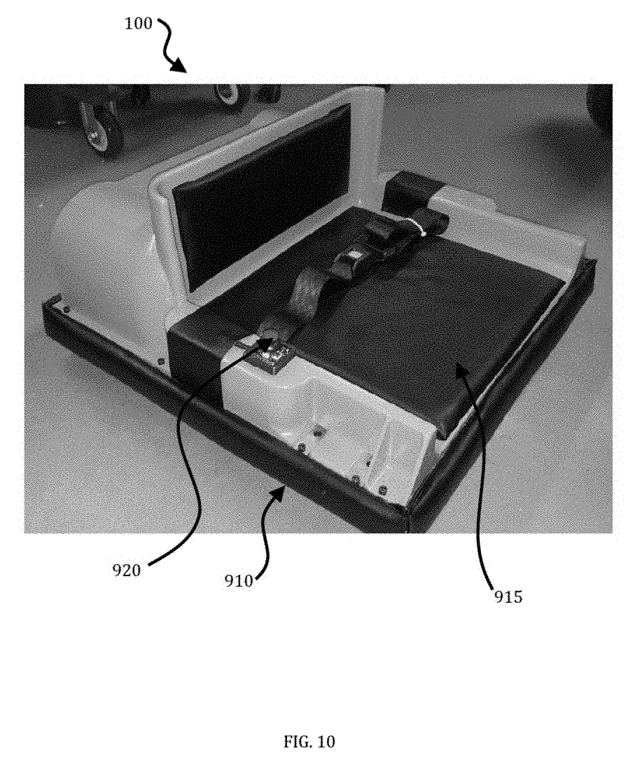

In certain embodiments the vehicle disclosed herein is designed to provide a number of advantages. Namely, the embodiments give toddlers the ability to choose when and where to move and provide the user the ability to experience and realize such movement independently. The embodiments are affordable and provide cost effective mobility assistance that bridge the gap between infancy, and the age or time at which the child is ready for a power wheel chair or other such device. The device is sized to allow easy ingress and egress for a child, provide sufficient clearance for navigation in a variety of indoor and outdoor environments, reduce or eliminate rough or sharp edges, and is capable of supporting the weight of a child. The vehicle can include a body cover that prevents the user from reaching under the device. As such, the device is intended to mitigate or eliminate the user's engagement with dangerous parts to prevent the user from harming themselves while using the device. The child mobility device 100 is illustrated in FIG. 10.

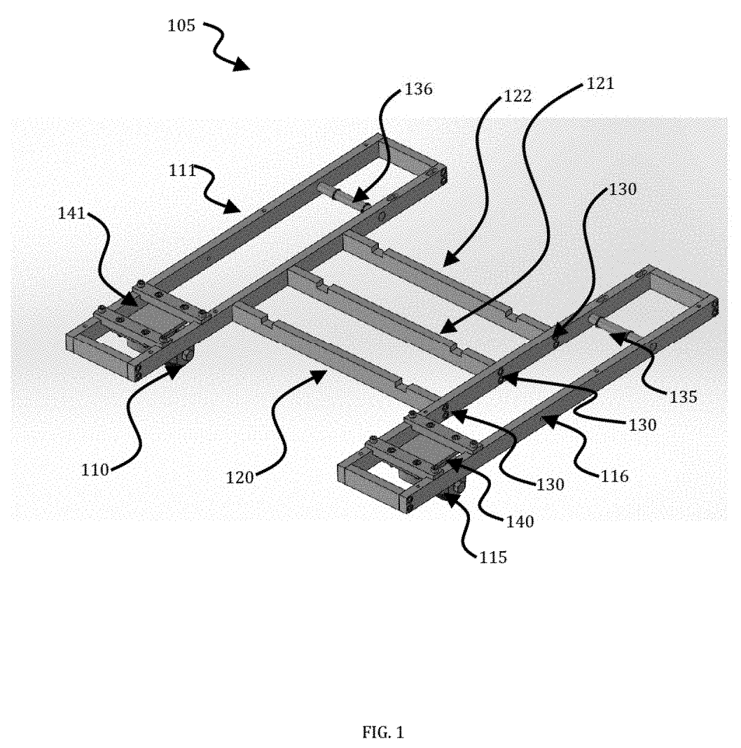

The child mobility device 100 comprises a chassis 105, as illustrated in FIG. 1. In an embodiment, the chassis 105 comprises a simple, lightweight skeleton (formed from metal or other such material as described herein) that possesses the necessary strength to support the weight of the remaining child mobility device 100 components and a user.

The chassis 105, illustrated in FIG. 1, shows the structure on which all the driving components of the child mobility device 100 can be placed. The wheels 110 and 115, respectively, of the child mobility device 100 can be enclosed by bar stock 111 and 116, respectively, in order to add distance between the edge of the body and any potential pinch points on the wheels.

A simple three-beam connection comprising beams 120, 121, and 122 can be used to connect bar stock 111 and 116. The crossbeams can include slots that are incorporated therein. The slots allow wires associated with the battery, electronics, and motors to pass under the shell. The three-beam connection provides strength to the chassis 105. Open space can be left in the chassis 105 to accommodate the electronics plate and motor controllers. Open space can also be left in the back of the chassis for the battery plate and motors.

A primary design consideration in the chassis 105 is informed by the fact that prior art power chairs are too large and/or tall to allow children to adequately explore their surroundings. Accordingly, in certain embodiments, the chassis 105 can be formed to be relatively small and close to the ground. This allows small children (i.e., toddlers) to easily mount and dismount the child mobility device 100. For example, in certain embodiments, the chassis 105 and/or the child mobility device 100 as a whole can have a footprint not exceeding two feet by two feet. These dimensions make the child mobility device 100 easy to move through standard doorways. The bottom of the chassis 105 can be 2.5 inches off the ground. This dimension is selected to be high enough to transition between floor surfaces, but low enough to maintain a low center of gravity and ease self-entrance for the user. It should be understood that, in other embodiments, other dimensions may be used.

The chassis 105 can be configured of materials that provide the necessary strength to weight characteristics. In certain embodiments, the chassis 105 can be formed from Aluminum 6061-T6 solid bar stock sections. This aluminum is lightweight and possesses sufficient yield strength.

In order to reduce stress on bolt threads, the three support beams 120, 121, and 122 can be bolted to the bar stock 111 and 116 from the sides with bolts 130, distributing the pressure between the bolts 130 axially.

The chassis 105 is designed so that the stress applied by the remaining device components, and the user, does not exceed the yield strength of the chassis 105. The maximum deformation of the center support beams 120, 121, and 122 was calculated to be 0.01033 millimeters. This is an acceptable amount that will not cause failure even after exceeding the maximum load capacity.

The chassis 105 can include holes that can be drilled in the bar stock for engagement with the cap head screws. The holes can be threaded so the screws can be tightened properly. Big heads in the shafts where the cap screws are installed can be provided to allow the screws to be flush with the surface. A similar process can be used for installing the crossbeams 120, 121, and 122. The holes are properly threaded for the cap screws used to hold them in place. In addition, shafts 135 and 136 for the wheels can be installed between the bar stock.

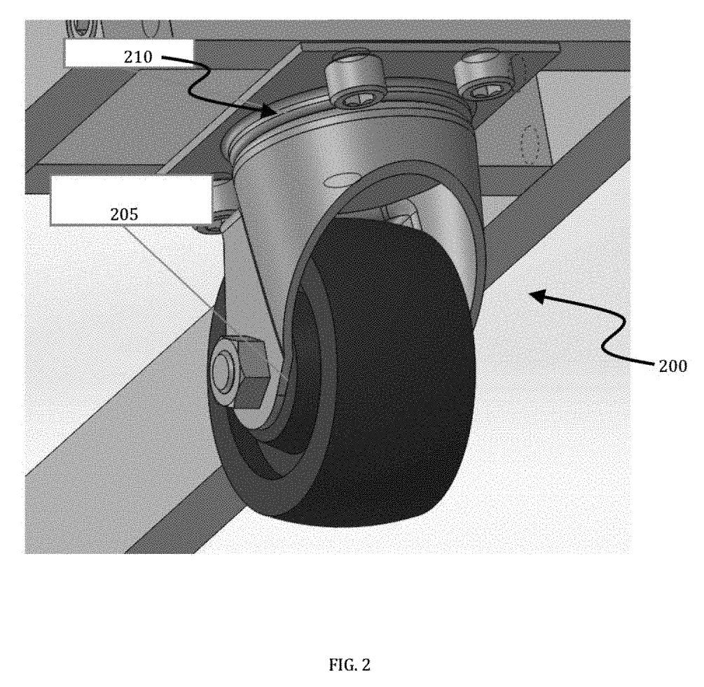

The front wheel assembly 200 of the child mobility device 100 can comprise caster wheels, such as caster wheel 205 illustrated in FIG. 2. Attachments 140 and 141, respectively, can be connected to chassis 105 with plates or cross braces that are used to mount the front wheel assembly 200, comprising caster 205, to the chassis 105. The front two wheels can thus comprise caster wheels that have a three hundred and sixty degree range of motion to guide the child mobility device 100 through an effortless, smooth turn.

The front wheel assembly 200 makes use of caster wheels 205 that are not connected to the drivetrain. The caster wheel assembly 200 helps the turning capability of the toddler mobility device 100 by providing a tight turning radius with a simple control mechanism. The front wheel assembly, illustrated in FIG. 2, can be configured to follow the motion of the drivetrain wheels in order provide a smooth turn. The turn smoothness is a result of the front wheel assembly 200, which includes a caster bearing 210 that is attached to the caster wheel 205. This allows for three hundred and sixty degree rotational freedom of the caster wheel 205. The turning freedom is the most important aspect of the disclosed embodiments because it cooperates with the drivetrain wheels in order to prevent sliding friction in the front casters 205 and the back wheels.

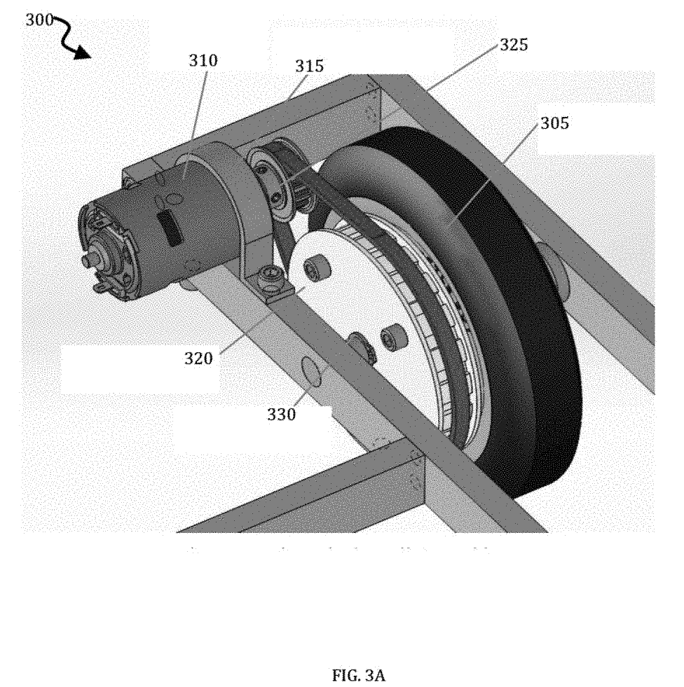

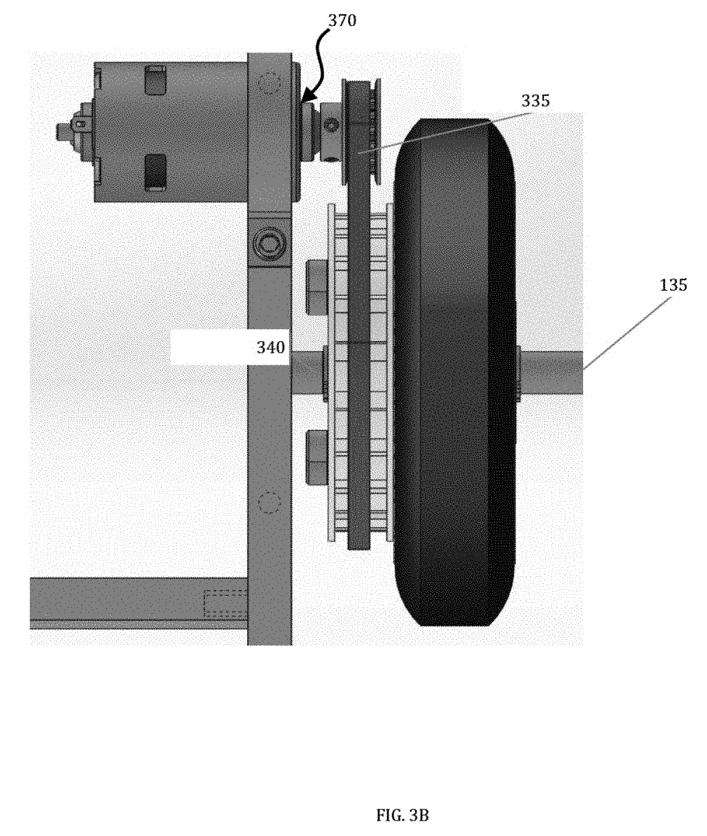

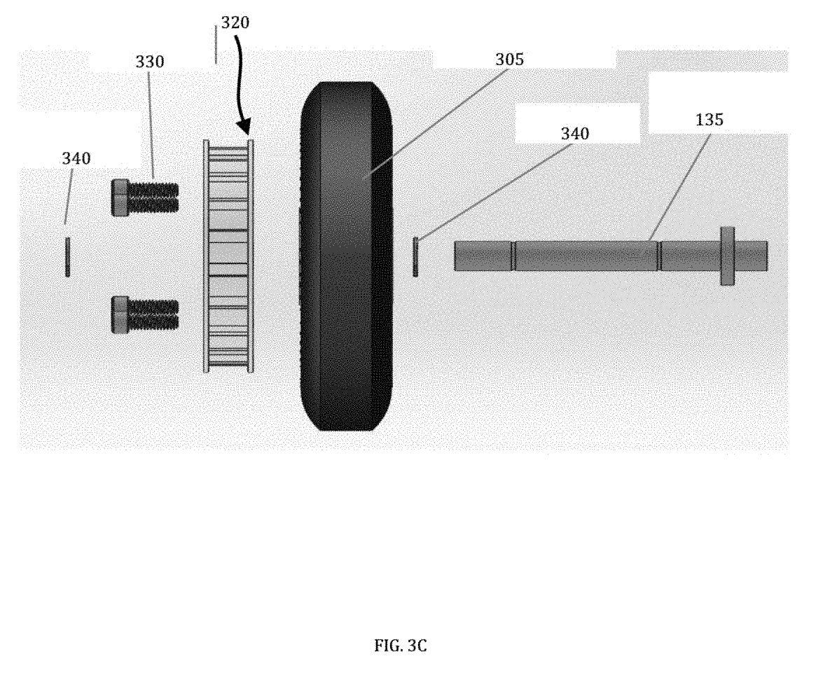

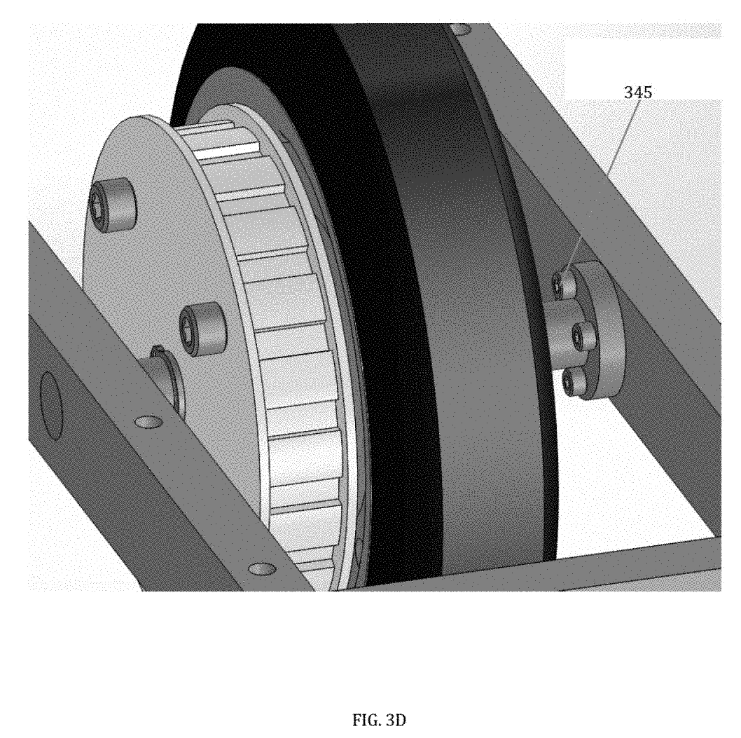

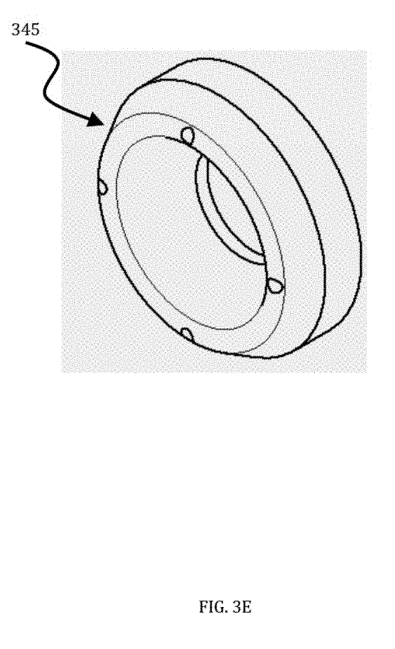

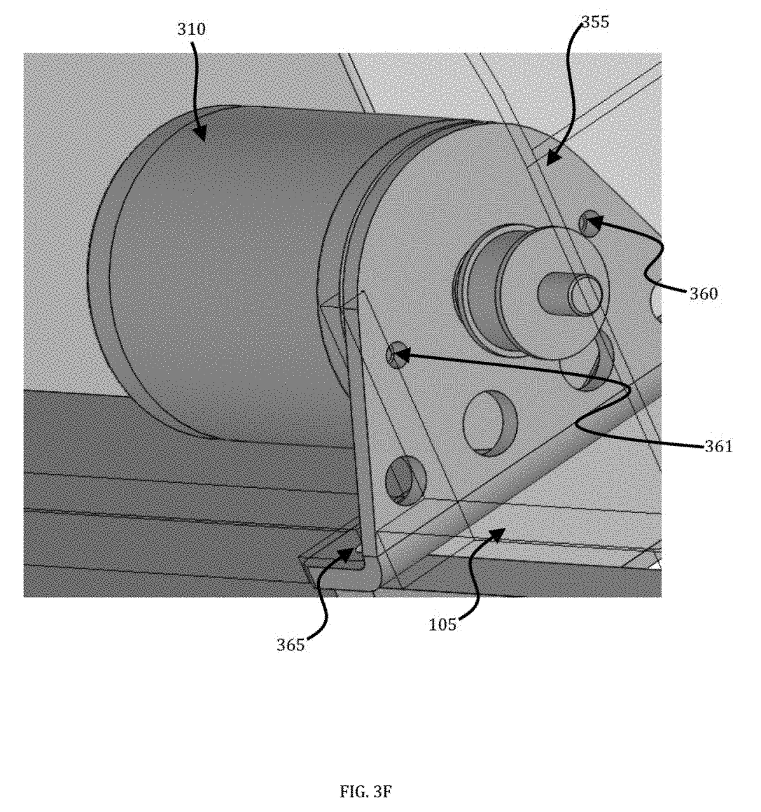

One or more drivetrain assemblies, such as a drivetrain assembly 300, illustrated in FIG. 3A, drive the toddler mobility device 100. Various embodiments and aspects of the drivetrain are further illustrated in FIGS. 3A-3F. The drivetrain is the mechanism in the toddler mobility device 100 that allows power from one or more motors, such as motor 310, to be transferred to the driving wheel 305. In certain embodiments, the toddler mobility device 100 can be driven with one or more rear driving wheels 305 while the two front caster wheels 205 are passively driven (e.g., the front wheel assembly 200, illustrated in FIG. 2). Each driving wheel 305 can be driven with a drivetrain assembly 300 independent of the other. This allows one of the driving wheels 305 to move forward while another moves backwards. When this occurs, it allows the operator to complete effortless, smooth turns and renders sliding friction negligible.

In an embodiment, the drivetrain comprises two separate, identical drivetrain assemblies 300 used to operate the back left and back right wheels, respectively, as illustrated in FIG. 3A. Each drivetrain assembly 300 comprises a motor 310, a driving pulley 315, a driven pulley 320, a timing belt 325, and a wheel 305.

The motor 310 turns the driving pulley 315, which turns the timing belt 325. The timing belt 325 is connected to the driven pulley 320. The driven pulley is bolted on to an adapter plate 345, as shown in FIG. 3D, that connects to the wheel 305 with a series of steel bolts 330. In certain embodiments, four bolts can be used, but other configurations of bolts can be selected according to design considerations. The wheel 305 and driven pulley 320 can rest on a stationary shaft (e.g., shaft 135 or 136) that is bolted to the chassis 105 as illustrated in more detail FIG. 3D.

The driving pulley 315 can be formed of aluminum or other such materials with the desired strength to weight ratio. In an exemplary embodiment, the driving pulley 315 can comprise a one-inch, double-flanged driving pulley with a hub, and a keyway 335 that is attached to the motor shaft 370. This arrangement is illustrated in FIGS. 3A and 3B. The motor shaft will have a key that fits into the keyway 335 that turns the driving pulley 315.

The driven pulley 320 can be formed from aluminum, or other such materials, with the desired strength to weight ratio. In an exemplary embodiment, the driven pulley 320 can comprise a four-inch, double flanged, no-hub timing pulley. The driven pulley 320 can be bolted onto the wheel's adapter plate 345. This transfers the rotation of the driven pulley 320 to the wheel 305, allowing the wheel 305 to move. In the exemplary embodiment of the pulley assembly, including the driving pulley 315 and driven pulley 320 connected by timing belt 325, a gear ratio of one to four is employed. Further details regarding the gear ratio are explained in detail herein.

The driven pulley 320 is bolted onto the drivetrain wheel's adapter plate 345, which is then placed between two snap rings 340 on a stationary shaft. This assembly is illustrated in FIG. 3C. The purpose of the snap rings 340 is to keep the wheel 305 and pulley in place on the stationary shaft 135. The drivetrain wheel assembly 300 receives power from the motor 310 and converts that power into rotational motion of the wheel 305 that allows the toddler mobility device 100 to move.

The timing belt 325 can comprise a one-side groove neoprene belt that synchronizes the driving pulley 315 to the driven pulley 320 by transferring the rotational motion from the driving pulley 315 to the driven pulley 320. While any suitable material can be used for the timing belt 325, neoprene has the advantage that it is a strong material that will not break under moderate fatigue.

An adapter plate 345 is illustrated in FIG. 3E. The adapter plate 345 fits into the grooves on the side of the wheel 305 and has a flat surface on the other side to facilitate connection with the driven pulley 320. The adapter plate 345 can be formed from an aluminum-based cylinder and milled so that the shaft fits through the plate. The driven pulley 320 can thus fit over the adapter plate and can be bolted to the adapter plate 345.

The drivetrain assembly 300 can be bolted to the chassis with connection assembly as shown in FIG. 3F. The connection assembly includes a series of bolts 345 that hold the shaft 135 in place on the chassis as shown in FIG. 3D.

A variety of electrically driven motors can be used as motor 310. In an exemplary embodiment, the motor 310 can comprise a “CIM” type DC motor, or other such similar motor. More specifically the motors 310 used to drive the child mobility device 100 can comprise full size commercially available DC motors, sized to fit the motor mounts. CIM motors are small enough to fit in the relatively small child mobility device and supply sufficient power to drive the child mobility device 100 with a toddler. In some embodiments, the power is sufficient to drive the child mobility device 100 with a toddler weighing up to 50 pounds.

Several characteristics of the electric motor 310 are noteworthy. First, a high torque occurs right as the motor starts to turn. Once the child mobility device 100 is moving, high torque is unnecessary and the motor speeds up to lower the current. As the motor shaft spins faster, both the torque and current of the motor decrease. The speed at which the motor 310 runs is, in general, on the high end of operational RPMs. This results in reduced current needed to run the motor. In turn, the reduced current provides longer battery life. Furthermore, the motor can be configured to run at less than full power, in order to further increase battery life.

Equation (1) illustrates the mathematical principle governing the improved battery life:

$$I = \frac{P}{V} \qquad ( 1 )$$

The required current, I, can be found by taking the power of the motor 310 and dividing by the voltage required to run the motor 310. As equation (1) illustrates, as the power is decreased, the amount of current used by the motor 310 decreases as well. Battery depletion is a function of current. Thus, reducing the current increases the battery life.

In certain embodiments, the device 100 can be governed to run at or below a safe speed for a child. This speed can be 2 miles per hour or less for the child mobility device 100. The rotational speed of the wheel necessary to maintain this maximum linear speed is given according to formula (2) as follows:

$$2 [ \frac{mile}{hour} ] * 5280 [ \frac{feet}{mile} ] * \frac{1}{60} [ \frac{hour}{minute} ] * \frac{1}{2 π * 3} [ \frac{rev}{in} ] * 12 [ \frac{in}{feet} ] = 112 [ \frac{rev}{minute} ] \qquad ( 2 )$$

The drivetrain wheel can thus be geared down from the driving pulley 315. According to equation (2), a desirable geared down ratio is 4 to 1, where the rotational speed multiplied by 4 results in 448 revolutions per minute. This is the maximum rotational rate at which the motor shaft can turn to run the child mobility device 100 at or below the desired linear speed.

In certain embodiments, the motor(s) 310 can be equipped with 1.5″ diameter, aluminum driving pulley 315 on the drive shaft 370. The shaft of the motor(s) 310 can be milled to have two flat sides, to line up with set screws on the driving pulley 315. This improves contact between the set screws and drive shaft, holding the driving pulley 315 more securely. The set screws can pass through set screw holes. Also, the motor mount 355 bracket is shown with the two holes 360 and 365 through it, providing access to the face of the motor such that bolts can be used to secure the motor to the motor mount 355. The holes on the bottom of the motor mount can be used to fasten the motor mount 355 to the chassis.

FIG. 3F illustrates the motor mounts 355 used to mount the motor 310 to the chassis 105. The chassis 105 is designed with holes 365 for mounting the motor mounts 355. The chassis 105 and/or motor mount is also configured with alternative hole patterns to give the ability to adjust the motor mounts 355 to allow for tensioning of the timing belt on the driving pulleys. The motor mount 355 can have bolts (e.g., two bolts) that secure it to the motor 310.

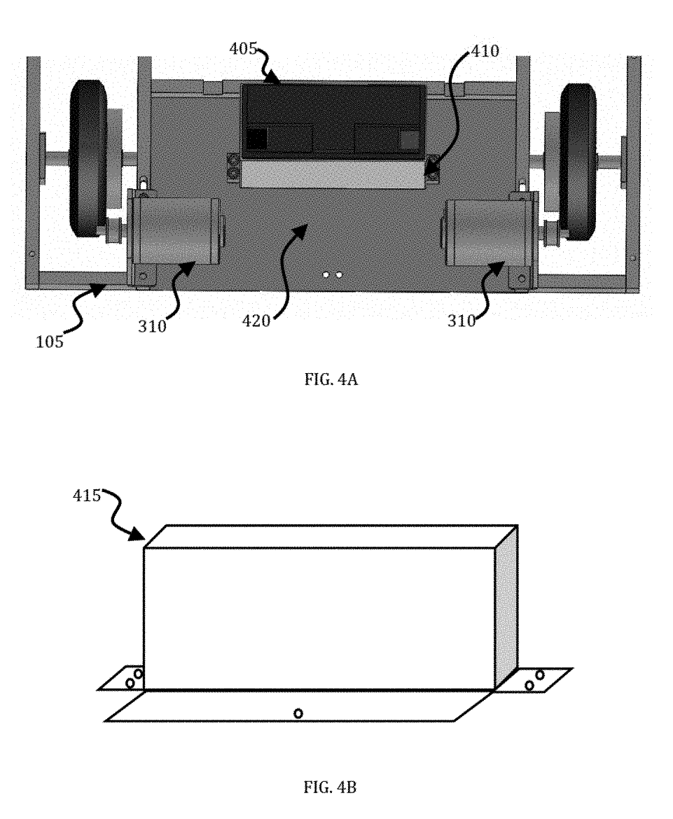

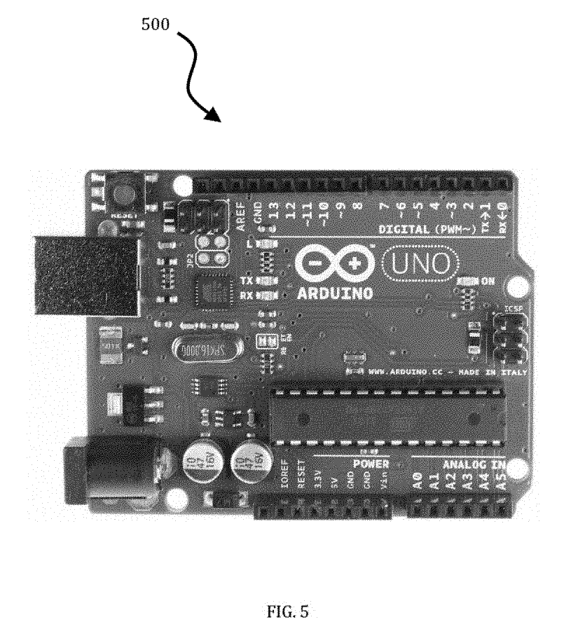

FIG. 4A illustrates chassis 105 from a top view with a battery 405 mounted thereon. The battery is selected to provide the longest possible life while maintaining a compact size, sufficient to fit on the chassis 105. The run time of the child mobility device 100 is dependent on the amp hour rating of the battery. In an exemplary embodiment, the battery 405 can be a 12 Volt, 18 Amp sealed lead acid rechargeable battery. Such a battery provides 1.2 hours of continuous power. In other embodiments, other batteries can be used according to design considerations.

The battery 405 can be mounted in an upward facing orientation, essentially standing toward the rear of the chassis 105. FIG. 4A illustrates part of the chassis 105 with various features mounted thereto. The battery 405 is so located to allowed ample room for the motors 105. With the battery upright, there is room for the motors and necessary wiring (further detailed below) while maintaining the desired small and compact overall footprint of the child motility device 100.

The upright orientation of battery 405 requires a specially designed battery mount assembly 410. The battery mount assembly 410 can comprise a sheet metal shroud 415. In other embodiments, the shroud 415 can be formed of other lightweight structural materials. The shroud 415 can enclose the rear, sides, and top of the battery 405 while the body shell encloses the front of the battery 405. The shroud 415 can be bolted to the battery plate 420 to secure the battery 405 in place on the chassis 105. The shroud 415 design is illustrated in FIG. 4B.

The child mobility device 100 is controlled with a series of electronic systems. It is desirable for the electronic components to be simple in order to make operation easy and to keep production costs low.

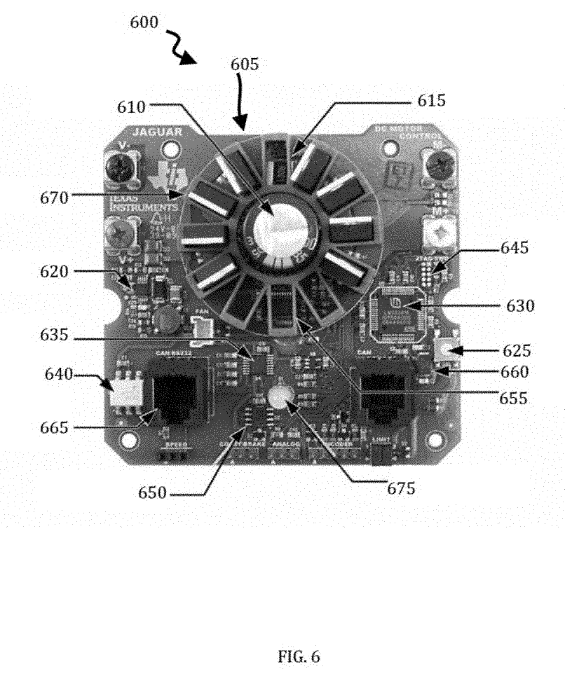

The child mobility device 100 can generally be controlled by a microcontroller 500 as illustrated in FIG. 5. The microcontroller 500 can comprise a single-board microcontroller, such as an Arduino™ type device. Such devices can comprise a microcontroller board and tools that can receive input and/or provide output to control objects. The microcontroller board can include one or more microprocessors and controllers. The boards can include digital and analog input/output (I/O) pins that can interface with other control boards or external devices. The microcontroller board can include serial communications interfaces, such as Universal Serial Bus (USB) that provides communication between the device and external devices, such as external computer, other controller, or motors.

The analog pins of the microcontroller 500 can receive an analog signal from a joystick, and PWM pins can provide a PWM frequency output. In an exemplary embodiment, a 2-axis joystick 810 is connected to the microcontroller 500 through the analog pins of the microcontroller. Code for controlling the microcontroller can include, but is not limited to, the Arduino ISP™ programming language.

The joystick 810 can comprise an analog input controller joystick. The joystick 810 is thus able to control the speed and direction of the mobility device. The joystick 810 comprises a 2-axis joystick that has potentiometers attached to the X and Y outputs. The potentiometers vary the voltage output values of joystick 810, which creates a variable speed controller. Wires can be connected to a breakout board of the joystick 810. Preferably, the joystick 810 has a large physical profile to make it easy and intuitive for a child to use.

Certain microcontrollers can only output 5 volts, which is generally not enough to power the 12-volt DC motors 310. Thus, motor controllers 600 can be used to route and controller power supply directly from the battery 405 to the motors 310. The motor controllers 600 have internal voltage regulators and a DC bus capacitor 610 to safely control that power, as well as a MOSFET H-bridge 670 that can change the current direction when necessary. The analog input signal from the joystick is sent to motor controllers 600, illustrated in FIG. 6, via a PWM connection 640. The motor controller 600 varies the voltage and current direction sent to the motors based on the PWM frequency. This allows the joystick to control both the speed and direction of the mobility device.

The exemplary motor controller 600, illustrated in FIG. 6, can comprise any motor controller, including a Jaguar™ motor controller. The motor controller 600 generally includes a PCB 605 with a current sense circuit 615 and a microcontroller 630. A switching power supply 620 is provided along with a user switch 625. A RS232 transceiver 635 is integrated on the PCB 605, which also houses a PWM input optocoupler 640, a JTAG/SWD connector 645, CAN Transceiver 650, a 6Pp6C/RS232 connector 665, gate driver 655, and 16 MHz crystal 660. A status LED 675 can also be provided.

The motor controller 600 is able to safely handle 40 amps of current, which they are commonly subject to in the disclosed applications, and can control both 12 and 24 Volt motors. The motor controller 600 controls the amount of power to send to the motors and the direction of the current.

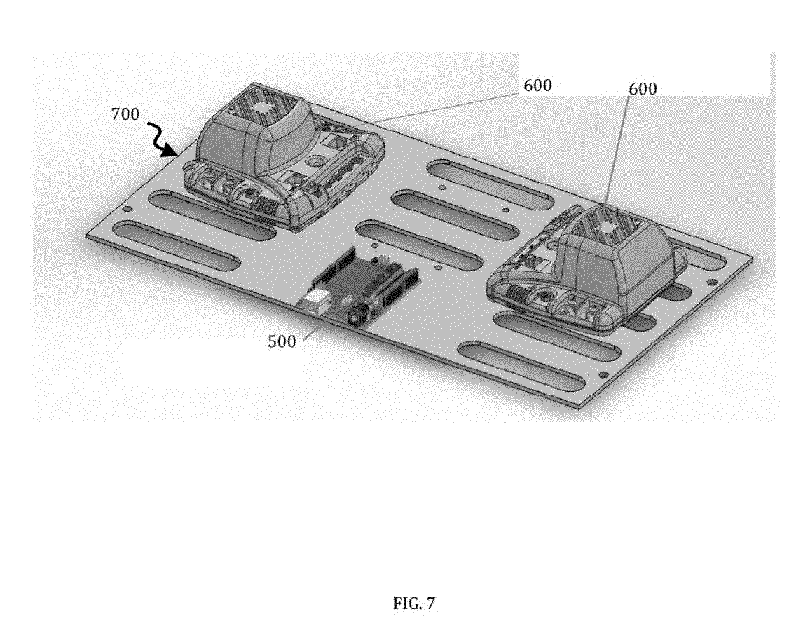

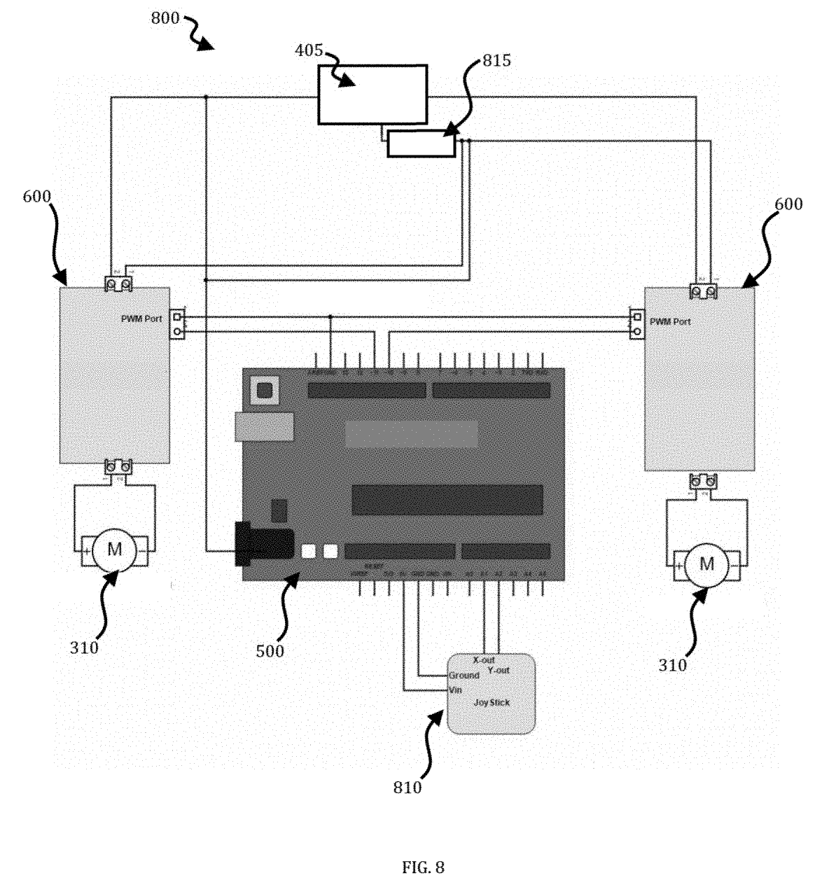

An exemplary embodiment of an electronics board 700 is illustrated in FIG. 7. The electronics board 700 can be configured from aluminum sheet metal (e.g., ⅛ inch thick) and can be sufficiently sized to house the microcontroller 500 and both motor controllers 600 (e.g., an area 8 by 16 inches). The electronics board 700 can be attached to the chassis 105 with cap head screw bolts. The electronics board 700 houses, not only the microcontroller 500 and the motor controllers 600, but also the connecting wires and power distribution breadboard. Through holes allow for the electronics to be easily attached to the board 700 by bolts and hex nuts. The electronics board 700 can be configured with a lightening pattern to reduce weight and material. This also provides routing for wires between electronic devices to be secured.

A wiring diagram 800 illustrating the connection of the various electronic components associated with the child mobility device 100 is provided in FIG. 8. The 12-volt DC rechargeable battery 405 powers the motors 310 and other electronics. The microcontroller 500 is connected to each of the motor controllers 600, which in turn control the power supplied to each of the motors 310, respectively. A joystick 810 provides input to the microcontroller 500.

The battery 405 is connected to a breadboard strip that distributes power from the battery 405. This creates a parallel circuit that draws more current and power while keeping the voltage at 12 volts. There is an on/off switch 815 between the battery and the breadboard that breaks the circuit and keeps the electronics from depleting the battery's charge.

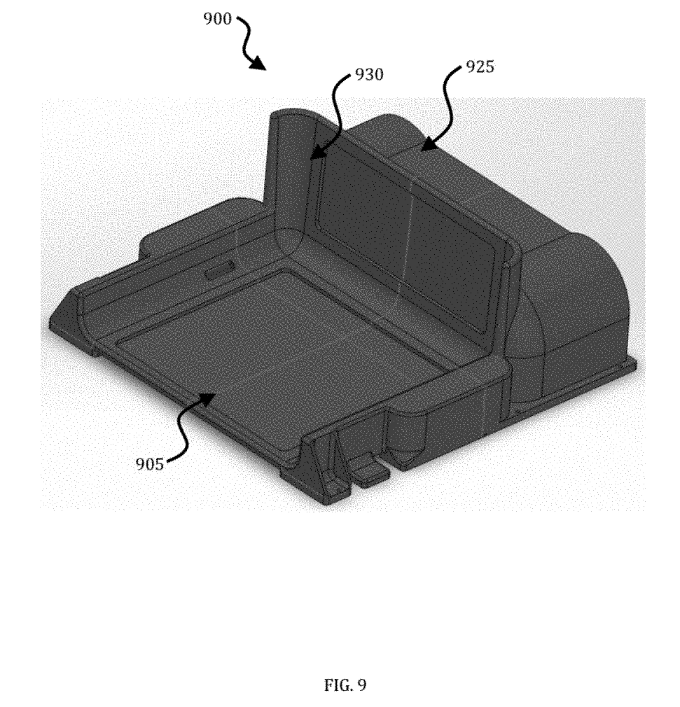

FIG. 9 illustrates a body or shell 900 associated with the child mobility device 100. The body 900 features a seat 905 and backrest 930, as well as fenders 910 to cover the wheels and provide space to route electrical wires. The body or shell 900 includes a large rear void 925 to house the motors, battery, and electronics. A pad 915 can be added to the seat to improve the comfort of using the child mobility device 100 and allow for much longer use.

The front of the seat 905 is open so a child can easily get into the seat. A seatbelt 920 can be included. Two slots are formed in the seat 905, one on each side, so a seatbelt can fit through the shell and attach to the chassis 105. The front of the body 900 also provides a large surface area so that a user can sit comfortably, even with their legs crossed. The angle of the seat 905 to the backrest 930 can be 93 degrees to improve user comfort although other seat angles can also be used. In some embodiments, different angles can be selected to improve ease of ingress and egress.

It is noteworthy that the body maintains a low profile so that a user is able to easily grab and interact with objects in front of them. It also provides good visibility in all directions while operating the mobility device.

The body 900 can be manufactured in any number of ways. In an exemplary embodiment, plastic vacuum sealing or 3D printing can be used. After completion, the body 900 can be attached to the chassis 105 with six cap head bolts. A piece of foam (not shown) can be provided between the body 900 and chassis 105. This allows for equal distribution of the patient's weight through the body 900 and the chassis 105. Cushions can be added as necessary, for example, on the bottom and back of the seat 905 to allow for a softer, more comfortable body design. The completed child mobility device 100, including the body attached to the chassis is illustrated in FIG. 10.

Based on the foregoing, it can be appreciated that a number of embodiments, preferred and alternative, are disclosed herein. For example, in one embodiment, a mobility system comprises a chassis, at least two casters attached to a front of the chassis, at least two wheels attached to a rear of the chassis, at least one motor operably connected to each of the at least two wheels, a battery configured to supply power to the at least one motor, a body affixed to the chassis and covering the chassis, and a control system wherein the control system provides manual control of the at least one motor. Each of the at least two wheels is operably connected to an independent motor.

In an embodiment, the control system further comprises a microcontroller operably connected to a joystick and a motor controller that receives control input from the microcontroller and adjusts power to the at least one motor.

In an embodiment, the body further comprises an integrated seat, a seat cushion on the seat, an integrated backrest, a backrest cushion on the backrest, and a seatbelt.

In an embodiment, the mobility system further comprises a battery plate attached to the chassis and a battery shroud attached to the battery plate and configured to secure the battery to the battery plate.

In an embodiment, the mobility system further comprises a drivetrain assembly that converts rotation of a drive shaft associated with the at least one motor into rotation of one of the at least two wheels. The drivetrain assembly further comprises a driving pulley affixed to the drive shaft, a timing belt, and a driven pulley driven by the timing belt. The mobility system further comprises an adapter plate that connects one of the at least two wheels to the driven pulley.

In an embodiment, the mobility system comprises a toddler mobility system configured for users weighing 50 pounds or less.

In another embodiment, a mobility apparatus comprises a chassis, at least two casters attached to a front of the chassis, at least two wheels attached to a rear of the chassis, at least one motor operably connected to each of the at least two wheels, a battery configured to supply power to the at least one motor, a body affixed to the chassis and covering the chassis, and a control system wherein the control system provides manual control of the at least one motor. Each of the at least two wheels is operably connected to an independent motor.

In an embodiment, the control system further comprises a microcontroller operably connected to a joystick, and a motor controller that receives control input from the microcontroller and adjusts power to the at least one motor.

In an embodiment, the mobility apparatus body further comprises an integrated seat, a seat cushion on the seat, an integrated backrest, a backrest cushion on the backrest, and a seatbelt.

In an embodiment, the mobility apparatus further comprises a battery plate attached to the chassis and a battery shroud attached to the battery plate and configured to secure the battery to the battery plate.

In an embodiment, the mobility apparatus further comprises a drivetrain assembly that converts rotation of a drive shaft associated with the at least one motor into rotation of one of the at least two wheels. The drivetrain assembly further comprises a driving pulley affixed to the drive shaft, a timing belt, and a driven pulley driven by the timing belt.

In an embodiment, the mobility apparatus further comprises an adapter plate that connects one of the at least two wheels to the driven pulley.

In an embodiment, the mobility apparatus comprises a toddler mobility apparatus configured for users weighing 50 pounds or less.

In another embodiment, a toddler mobility system comprises a chassis, at least two casters attached to a front of the chassis, at least two wheels attached to a rear of the chassis, a first motor operably connected to one of the at least two wheels, a second motor operably connected to another of the at least two wheels, a battery configured to supply power to the first motor and the second motor, a body affixed to and covering the chassis, the body further comprising an integrated seat, an integrated backrest, a seat belt, a control system wherein the control system further comprises a microcontroller operably connected to a joystick, and a motor controller that receives control input from the microcontroller and adjusts power to the first motor and the second motor independently, wherein the system comprises a toddler mobility system configured for users weighing 50 pounds or less.

In another embodiment, the toddler mobility system further comprises at least two drivetrain assemblies that converts rotation of a drive shaft into rotation of one of the at least two wheels, the drivetrain assembly further comprising a driving pulley affixed to the drive shaft, a timing belt, and a driven pulley driven by the timing belt.

It will be appreciated that variations of the above-disclosed and other features and functions, or alternatives thereof, may be desirably combined into many other different systems or applications. Also, it will be appreciated that various presently unforeseen or unanticipated alternatives, modifications, variations or improvements therein may be subsequently made by those skilled in the art which are also intended to be encompassed by the following claims.

What is claimed is:

1. A mobility system comprising:
a chassis;
at least two casters attached to a front of said chassis;
at least two wheels attached to a rear of said chassis;
at least one motor operably connected to each of said at least two wheels;
a battery configured to supply power to said at least one motor;
a body affixed to said chassis and covering said chassis; and
a control system wherein said control system provides manual control of said at least one motor.

2. The mobility system of claim 1 wherein each of said at least two wheels is operably connected to an independent motor.

3. The mobility system of claim 1 wherein said control system further comprises:
a microcontroller operably connected to a joystick; and
a motor controller that receives control input from said microcontroller and adjusts power to said at least one motor.

4. The mobility system of claim 1 wherein said body further comprises:
an integrated seat;
a seat cushion on said seat;
an integrated backrest;
a backrest cushion on said backrest; and
a seatbelt.

5. The mobility system of claim 1 further comprising:
a battery plate attached to said chassis; and
a battery shroud attached to said battery plate and configured to secure said battery to said battery plate.

6. The mobility system of claim 1 further comprising:
a drivetrain assembly that converts rotation of a drive shaft associated with said at least one motor into rotation of one of said at least two wheels.

7. The mobility system of claim 6 wherein said drivetrain assembly further comprises:
a driving pulley affixed to said drive shaft;
a timing belt; and
a driven pulley driven by said timing belt.

8. The mobility system of claim 7 further comprising:
an adapter plate that connects one of said at least two wheels to said driven pulley.

9. The mobility system of claim 1 wherein said system comprises a toddler mobility system configured for users weighing 50 pounds or less.

10. A mobility apparatus comprising:
a chassis;
at least two casters attached to a front of said chassis;
at least two wheels attached to a rear of said chassis;
at least one motor operably connected to each of said at least two wheels;
a battery configured to supply power to said at least one motor;
a body affixed to said chassis and covering said chassis; and
a control system wherein said control system provides manual control of said at least one motor.

11. The mobility apparatus of claim 10 wherein each of said at least two wheels is operably connected to an independent motor.

12. The mobility apparatus of claim 10 wherein said control system further comprises:
a microcontroller operably connected to a joystick; and
a motor controller that receives control input from said microcontroller and adjusts power to said at least one motor.

13. The mobility apparatus of claim 10 wherein said body further comprises:
an integrated seat;
a seat cushion on said seat;
an integrated backrest;
a backrest cushion on said backrest; and
a seatbelt.

14. The mobility apparatus of claim 10 further comprising:
a battery plate attached to said chassis; and
a battery shroud attached to said battery plate and configured to secure said battery to said battery plate.

15. The mobility apparatus of claim 10 further comprising:
a drivetrain assembly that converts rotation of a drive shaft associated with said at least one motor into rotation of one of said at least two wheels.

16. The mobility apparatus of claim 15 wherein said drivetrain assembly further comprises:
a driving pulley affixed to said drive shaft;
a timing belt; and
a driven pulley driven by said timing belt.

17. The mobility apparatus of claim 16 further comprising:
an adapter plate that connects one of said at least two wheels to said driven pulley.

18. The mobility apparatus of claim 10 wherein said apparatus comprises a toddler mobility apparatus configured for users weighing 50 pounds or less.

19. A toddler mobility system comprising:
a chassis;
at least two casters attached to a front of said chassis;
at least two wheels attached to a rear of said chassis;
a first motor operably connected to one of said at least two wheels;
a second motor operably connected to another of said at least two wheels;
a battery configured to supply power to said first motor and said second motor;
a body affixed to and covering said chassis, said body further comprising an integrated seat, an integrated backrest, and a seat belt; and
a control system wherein said control system further comprises a microcontroller operably connected to a joystick, and a motor controller that receives control input from said microcontroller and adjusts power to said first motor and said second motor independently;
wherein said system comprises a toddler mobility system configured for users weighing 50 pounds or less.

20. The toddler mobility system of claim 19 further comprising:
at least two drivetrain assemblies that convert rotation of a drive shaft into rotation of one of said at least two wheels, said drivetrain assembly further comprising a driving pulley affixed to said drive shaft, a timing belt, and a driven pulley driven by said timing belt.
